(19) United States
(12) Patent Application Publication
(10) Pub. No.: US 2024/0421433 A1
(43) Pub. Date: Dec. 19, 2024

(54) METHOD FOR PRODUCING AN ELECTRODE SEPARATOR COMPOSITE

(71) Applicant: Volkswagen Aktiengesellschaft, Wolfsburg (DE)

(72) Inventors: Christian KLEMT, Meine (DE); Tobias JANSEN, Braunschweig (DE); Alexander TORNOW, Ummern (DE); Marco JORDAN, Salzgitter (DE); Adrian BECKER, Bockenem (DE); Dennis BOEHM, Wolfenbuettel (DE)

(73) Assignee: Volkswagen Aktiengesellschaft, Wolfsburg (DE)

(21) Appl. No.: 18/814,556

(22) Filed: Aug. 25, 2024

Related U.S. Application Data
(63) Continuation of application No. PCT/EP2023/052919, filed on Feb. 7, 2023.

(30) Foreign Application Priority Data
Feb. 24, 2022 (DE) 10 2022 201 947.4

(51) Int. Cl. H01M 50/46; H01M 50/406

(52) U.S. Cl. CPC H01M 50/461; H01M 50/406

(57) ABSTRACT

A method for producing an electrode separator composite, which is a component of an electrode separator stack for a battery cell, and which electrode separator composite is formed of at least one electrode layer and at least one separator layer. The method comprises the following steps: a laying process, in which the electrode and separator layers are laid on top of one another; and a joining process, with which an adhesive connection is formed between the electrode and separator layers laid on top of one another. The joining process involves a plasma treatment, in which there is a surface activation of the electrode and/or separator layers using plasma, such that an adhesive connection is provided between the respective joining partners.

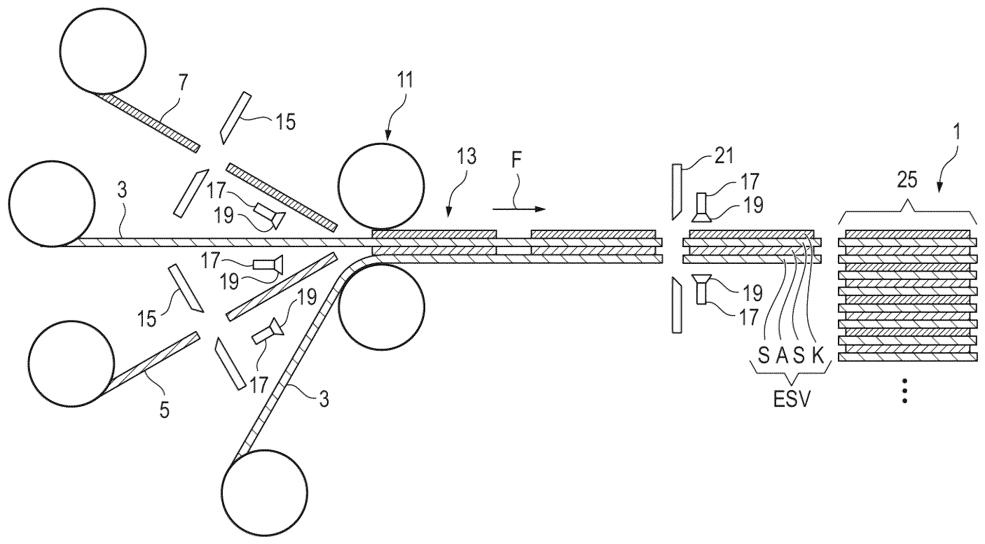

This nonprovisional application is a continuation of International Application No. PCT/EP2023/052919, which was filed on Feb. 7, 2023, and which claims priority to German Patent Application No. 10 2022 201 947.4, which was filed in Germany on Feb. 24, 2022, and which are both herein incorporated by reference.

### BACKGROUND OF THE INVENTION

### Field of the Invention

The invention relates to a method for producing an electrode separator composite.

### Description of the Background Art

In the production of a lithium-ion cell, in principle an electrode separator stack must be built which is made up of a plurality of electrodes (anode or cathodes) which lie on top of one another in alternation and which are insulated from one another by a separator. Due to the large number of these individual elements and the necessary high layer tolerances, the production of such an electrode separator stack is particularly critical with regard to the cycle time and the reject rate. One option for making this necessary step productive is to produce an electrode separator composite (i.e., a unit cell or monocell) and to stack such electrode separator composites to form an electrode separator stack. The electrode separator composite thus forms the smallest unit in the electrode separator stack.

A generic method for producing an electrode separator composite encompasses a laying process in which the electrode layers and separator layers are laid on top of one another, and a joining process via which an adhesive bond is formed between the superposed electrode layers and separator layers.

The joining process is implemented as a lamination process in the prior art. In this process, the individual elements of the electrode separator composite (separator/anode/separator/cathode, for example) are joined together by pressure and temperature. At the present time, this takes place by depositing individual anodes onto a continuous separator film and subsequently covering them with a further separator film. Individual cathodes are in turn deposited on this composite made up of a separator/anode/separator.

The special feature of the above lamination process is that separators that are precoated, at least on one side, with an adhesion-promoting layer are generally used. The coating is usually made of PVDF, which within the scope of the lamination processes melts, thus ensuring the adhesion of the individual layers to one another. The electrode separator stack is produced in a subsequent stacking process, using the electrode separator composites produced in this way.

The use of separators provided with adhesion-promoting layers entails significant costs in the production and use of such insulation layers. In addition, the joining process may take place solely under the simultaneous effect of temperature and pressure. Furthermore, on account of process principles, the productivity of the lamination processes using heating presses, double belt presses, or the like, for example, is limited, since a temperature-pressure regime must be maintained. Moreover, the lamination process has low energy efficiency, since the energy expended in the lamination process is lost as waste heat. Thermal loads in machines and facilities for battery cell manufacture are to be regarded as critical due to the environmental requirements (defined air conditioning).

A device for manufacturing electrodes for lithium-ion batteries is known from DE 10 2020 007 718 A1, which corresponds to US 2021/0193986.

### SUMMARY OF THE INVENTION

It is therefore an object of the invention to provide a method for producing an electrode separator composite for a battery cell, which in terms of process engineering has a simpler design compared to the prior art.

The invention relates to a method for producing an electrode separator composite which is an integral part of an electrode separator stack for a battery cell. The electrode separator composite forms the smallest unit of the electrode separator stack, and is also known as a monocell or unit cell. The electrode separator composite according to the invention is made up of electrode layers lying on top of one another in a known manner, with at least one separator layer situated in between. The electrode separator composite is generally produced via the following process steps: In a laying process, the electrode layers and separator layers are laid on top of one another. In a joining process, a sufficiently strong adhesive bond (adhesion) is formed between the superposed electrode layers and separator layers. This joining process is no longer implemented as a lamination process with appropriate action by heat and pressure. Rather, the joining process involves a plasma treatment in which there is surface activation of the electrode layers and/or separator layers, using plasma. By use of the plasma treatment, an increased chemical adhesive bond is provided, preferably by means of covalent bonds, which ensure sufficiently strong adhesion between the respective joining partners.

The plasma treatment can precede the laying process. In this case, in the laying process the electrode layers and/or separator layers pretreated with plasma may be placed on top of one another to form the covalent bonds between neighboring layers.

With regard to mass production, it is preferred when the method for producing the electrode separator composite is designed as a continuous process. In this case, the electrode layers and separator layers are provided as continuous sheet material and led together through a roller gap of a pair of pressure rollers, in particular to form a continuous layer composite. This continuous layer composite is cut to length in a subsequent cutting process to form individual electrode separator composites.

In the above process configuration, the at least one plasma source can be situated at the roller gap inlet of the pair of pressure rollers, via which the surface activation of the electrode layers and/or separator layers may be carried out.

After the cutting process, it is common practice to carry out a stacking process in which the individual electrode separator composites are stacked to form an electrode separator stack. In the prior art, this electrode separator stack must be stabilized in a further process (a taping process, for example) to ensure ease of handling of the electrode separator stack for the further process sequence. As an alternative and/or in addition to the above-described plasma treatment of the individual electrode layers and/or separator layers, a further plasma treatment may be provided. This further plasma treatment precedes the stacking process, and brings about surface activation of the particular electrode separator composite by means of plasma. In this way, an increased adhesive bond is provided by covalent bonds between electrode separator composites that are stacked on top of one another.

According to the invention, the surface activation by plasma treatment may be carried out on one or both sides of the particular layer or the particular electrode separator composite. The surface activation may be carried out either continuously or in stages, depending on the process control.

A significant advantage of the plasma treatment according to the invention is that, in contrast to the conventional lamination process, it may be carried out at room temperature, i.e., without the influence of a high process temperature. This results in major benefits with regard to the productivity and energy efficiency. In addition, more economical, i.e., thermally unstable, starting materials may be used for the product.

In the plasma treatment a gas discharge takes place in a gas atmosphere in a manner known as such, in which the process gas flows past a discharge path, where it is excited and converted into the plasma state. In the further course of the process, the plasma formed in this way may pass through a plasma nozzle and onto the surface of the electrode layer and/or separator layer to be treated. To increase the adhesive bond, it is preferred when additional auxiliary substances (i.e., precursors) are added to the process gas. As an example, such precursors may be nitrogen compounds or silate compounds. UV-activatable joining auxiliary substances may optionally also be added.

Overall, at least the following advantages listed in summary form are achieved by use of the invention: the joining process is extremely energy-efficient; cost advantages for the starting products used (omission of adhesion-promoting layers of the separator); significantly lower thermal loads on joining partners; integrated pretreatment and joining process; adjustability of the properties of the joining bond by use of precursors; any desired cell structures are achievable; continuous (R2R) and discontinuous (R2S, stacking) joining are possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole figure illustrates a facility diagram for producing an electrode separator stack.

### DETAILED DESCRIPTION

An example of the invention is described below with reference to the figure. A facility diagram for producing an electrode separator stack 1 is indicated in the figure by way of example. This electrode separator stack may be installed in a cell housing of a lithium-ion battery cell. The electrode separator stack 1 is made up of a plurality of electrode separator composites ESC that are stacked on top of one another. Each electrode separator composite ESC is built from a bottom separator layer S, a middle cathode layer K, a middle separator layer S, and a top anode layer A.

It is emphasized that the invention is not limited to the electrode separator composite ESC indicated in the figure. Instead, the electrode layers and the separator layers in the electrode separator composite ESC may be stacked in any other desired manner. For example, the electrode separator composite ESC may be built from exactly one electrode layer and exactly one separator layer S. Alternatively, the electrode separator composite ESC, viewed in the stacking direction, may be built from a separator layer S, an electrode (A or K), and a separator layer S. In addition, the electrode separator composite ESC, viewed in the stacking direction, may be built from a separator layer S, a first electrode (A or K), a separator layer S, and a second, oppositely poled electrode (K or A). Mixed forms are also conceivable.

According to the figure, for producing the electrode separator composite ESC, the two separator layers S and the two anode layers and cathode layers A, K are initially provided as continuous film sheets 3, 5, 7. The total of four continuous film sheets are led through a roller gap of a pair of pressure rollers 11 in a production direction F. A continuous laying process takes place by use of the pair of pressure rollers 11, in particular to form a continuous layer composite 13 at the roller gap outlet of the pair of pressure rollers 11. The two separator film sheets 3 are led through the roller gap without a preceding cutting operation, i.e., as continuous film sheets, while the anode film sheet 5 and the cathode film sheet 7 are separated into individual layers in upstream cutting stations 15. Correspondingly, the separated anode layers A are deposited on the bottom side of the middle separator film sheet 3, while the separated cathode layers K are deposited on the top side thereof. The anode layers A are also covered by the bottom separator film sheet 3.

The core of the invention is that a plasma treatment station with plasma sources 17 is situated upstream from the pair of pressure rollers 11. These plasma sources are situated directly at the roller gap inlet of the pair of pressure rollers 11. Surface activation of the electrode film sheets and/or separator film sheets 3, 5, 7 takes place by means of the plasma sources 17. In this way, a sufficiently strong adhesive bond is provided by covalent bonds between the respective layers S, A, S, K, which provide sufficiently strong adhesion in the formed continuous layer composite 13 after passing through the roller gap.

The plasma treatment is carried out approximately at room temperature. In the plasma treatment, in common practice a gas discharge takes place in a gas atmosphere. The process gas flows past a discharge path, where it is excited and converted into a plasma state. In the further course of the process, the plasma formed in this way is applied via a plasma nozzle 19 to the surface of the particular electrode film sheet and/or separator film sheet 3, 5, 7. Auxiliary substances are preferably added to the process gas, by means of which the adhesive bond in the continuous layer composite 13 is increased.

In the figure, situated downstream from the pair of pressure rollers 11 is a cutting station 21 in which the continuous layer composite 13 is cut to length to form individual electrode separator composites ESC. As indicated in the figure, as an alternative or in addition to the first plasma treatment, the electrode separator composites ESC may be supplied to a further plasma treatment station 23 in which surface activation of the particular electrode separator composite ESC takes place, likewise by use of plasma sources 17. An increased adhesive bond by means of covalent bonds between electrode separator composites ESC is provided by use of this plasma treatment. The electrode separator composites ESC are subsequently stacked on top of one another in a stacking station 25.to form the electrode separator stack 1.

In particular for use of a plasma treatment that takes place in the plasma treatment station 23, it is relevant that the electrode separator composite ESC, viewed in the stacking direction, is built from an anode layer A, a separator layer S, a cathode layer K, a separator layer S, and an anode layer A.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing an electrode separator composite that is an integral part of an electrode separator stack for a battery cell, the electrode separator composite being formed from at least one electrode layer and at least one separator layer, the method comprising:
a laying process in which at least one electrode and a separator layer are laid on top of one another; and
a joining process via which an adhesive bond is formed between at least one electrode layer and a separator layer, the joining process comprising a plasma treatment in which activation of the surface of the at least one electrode layer and/or separator layer takes place using plasma so that an increased adhesive bond, via covalent bonds, is provided between the respective joining partners.

2. The method according to claim 1, wherein the plasma treatment is carried out prior to the laying process, so that in the laying process the electrode layers and/or separator layers that are pretreated with plasma are laid on top of one another.

3. The method according to claim 1, wherein the laying process is a continuous process in which the electrode layers and separator layers, which are still separate from one another, are led together as continuous film sheets through a roller gap of a pair of pressure rollers to form a continuous layer composite, which in a subsequent cutting process is cut to length to form individual electrode separator composites.

4. The method according to claim 3, wherein at least one plasma source is arranged upstream from the pressure region, which includes a conveyor belt instead of a roller, at the input side, via which the surface activation of the continuous electrode sheets and/or separator sheets is carried out.

5. The method according to claim 3, wherein after the cutting process, a stacking process takes place in which the electrode separator composites are stacked to form an electrode separator stack for stabilizing the electrode separator stack, the stacking process is preceded by a further plasma treatment in which surface activation of the particular electrode separator composite takes place using plasma so that an adhesive bond is provided by covalent bonds between electrode separator composites that are stacked on top of one another.

6. The method according to claim 1, wherein the surface activation by plasma treatment is carried out on one or both sides of a separator layer and/or on a separator layer and/or on an electrode layer and/or the surface activation is carried out continuously or in stages.

7. The method according to claim 1, wherein the plasma treatment is carried out at room temperature, and/or during the plasma treatment a gas discharge takes place in a gas atmosphere, with the process gas flowing past a discharge path, where it is excited and converted into the plasma state, and in the further course of the process, the plasma formed in this way passes through a plasma nozzle and onto the surface of the electrode layer and/or separator layer to be treated, and/or auxiliary substances are added to the process gas, via which the adhesive bond between the joining partners is increased.

8. The method according to claim 1, wherein the electrode separator composite, viewed in a stacking direction, is built from a separator layer, an electrode, and a separator layer, or wherein the electrode separator composite, viewed in the stacking direction, is built from a separator layer, a first electrode, a separator layer, and a second, oppositely poled electrode.

9. A method for producing an electrode separator composite which is an integral part of an electrode separator stack for a battery cell, the electrode separator composite being formed from at least one electrode layer and at least one separator layer, the method comprising:
performing a plasma treatment in which surface activation of the electrode separator composites takes place via plasma, so that an increased adhesive bond, via covalent bonds, is provided between the particular joining partners; and
performing a stacking process step in which a plurality of electrode separator composites are stacked to form the electrode separator stack, the stacking process step being preceded by the plasma treatment.

10. The method according to claim 9, wherein the electrode separator stack produced by a plasma treatment terminates with an anode at each of its two stack ends, and/or in the electrode separator composite, viewed in the stacking direction, is built from an anode layer, a separator layer, a cathode layer, another separator layer, and another anode layer.
